(19) United States
(12) Patent Application Publication
(10) Pub. No.: US 2009/0088547 A1
(43) Pub. Date: Apr. 2, 2009

(54) Process for producing polysiloxanes and use of the same

(75) Inventors: Andrew Schamschurin, Acton (AU); Graham Roy Atkins, Kaleen (AU); Dax Kukulj, Acton (AU)

Correspondence Address: Thomas A Miller;Miller, Matthias & Hull, Suite 2350, One North Franklin Street, Chicago, IL, 60606, US

(73) Assignee: RPO Pty Limited, Acton (AU)

(21) Appl. No.: 11/582,933

(22) Filed: Oct. 17, 2006

(51) Int. Cl. C08G 77/08

(52) U.S. Cl. 528/14

(57) ABSTRACT

A process for the preparation of an organosilicon condensate which comprises reacting together a silicon containing compound having at least one silanol group and a silicon containing compound having at least one —OR group or at least one silanol group (or a compound having both groups) in the presence of strontium oxide, barium oxide, strontium hydroxide or barium hydroxide and optionally a solvent such as water, methanol, ethanol, 1-propanol, 2-propanol, 1-butanol and 2-butanol, acetone or toluene.

### CROSS-REFERENCE TO RELATED DOCUMENTS

The present invention is related in part to U.S. Pat. Nos. 6,965,006 and U.S. Pat. No. 6,818,721 and U.S. application Ser. Nos. 10/694,928, 10/350,387, 10/484,219, 10/484,273, 11/257,736, 11/298,962, 60/729,628; all of which are included in their entirety herein by reference and are owned by the same assignee.

### FIELD OF THE INVENTION

The present invention relates to processes for the production of polysiloxanes, and in particular to processes which yield siloxanes through the condensation of two silanol groups (SiOH) or the condensation of a silanol group with a silicon-bonded alkoxy group (SiOR).

### BACKGROUND

Organosilicon polymers, and polysiloxanes (linear alternating Si—O backboned polymers) in particular, have found use in a variety of fields. However, their good light transmission properties, substrate adhesion and mechanical and chemical stability over an extended temperature range make them attractive targets for use in optical materials such as optical waveguides and devices. Of particular interest is the fact that the mechanical, optical and chemical properties of polysiloxanes can be controlled and modified by variation of the starting monomer compositions and by control of reaction conditions.

One method commonly employed for the preparation of organosilicon polymers, often described as the ‘sol-gel method’, involves the hydrolysis of silicon alkoxides in organic solution with stoichiometric amounts of water in the presence of catalytic quantities of acid. Such reaction conditions often result in significant residual quantities of OH groups (either from water or silanol groups (i.e. Si—OH) or both) in the reaction mixture that are often difficult to remove. One consequence of having residual silanol groups is that they will continue to condense with each other, increasing the network connectivity until the material eventually gels (ie solidifies). This not only limits the shelf life of the product polymers, but their viscosity will increase continually. Even when the polymer is deposited and cured, uncondensed silanol groups can still continue a slow reaction over the service life of the polymeric material, which can lead to cracking and loss of adhesion. Residual silanol groups are even more disadvantageous in the field of polymer optics, where a low OH content is highly desirable in any polymeric light transmissive material. OH groups cause a strong absorption band at 3500 cm⁻¹ (2860 nm) that adversely affects optical transparency at the important telecommunications wavelength of 1550 nm, via the first overtone band at 1430 nm.

Alternative routes to organosilicon polymers of more controlled functionality are via the condensation of molecules bearing one or more silanol groups (the ‘silanol plus silanol’ route), or condensation of molecules bearing one or more silanol groups with molecules bearing one or more silicon-bonded alkoxy groups (ie SiOR groups, where R is typically a short chain alkyl hydrocarbon). This ‘silanol plus alkoxysilane’ route is particularly attractive, because it is an asymmetric condensation. Such asymmetric condensation reactions, for example the ‘head to tail’ condensation of a single compound bearing both silanol and alkoxysilane groups, or the alternating condensation of diols and dialkoxy, trialkoxy or tetraalkoxy compounds, allow a degree of regularity to be imparted into a polysiloxane by the use of a simple choice of starting monomers, as well as ready introduction of a variety of functional groups. For optical applications in particular, various groups may be introduced to tune the refractive index, reduce the optical absorption, or impart curability by exposure to heat or energetic radiation.

The ‘silanol plus silanol’ and ‘silanol plus alkoxysilane’ routes can be represented together as the following general condensation reaction, where the condensation by-product XOH is water (for X═H) or an alcohol (for X═R):

≡Si—OH+XO—Si≡→≡Si—O—Si≡+XOH

Materials produced by condensation of silicon-containing compounds are referred to as ‘organosilicon condensates’ or ‘organosilicon polymers’. These materials may have a linear structure or they may be branched at one or more of the silicon atoms in the macromolecule. A particular advantage of the condensation reactions of the present invention is that they can be used to prepare well-defined, linear organosilicon polymers that are commonly referred to as ‘polysiloxanes’, ‘siloxane polymers’ or ‘silicones’. For example, one or more hydroxy-terminated siloxane compounds of low molecular weight may undergo a condensation reaction to produce a higher molecular weight siloxane polymer, as represented by the following reaction:

HO—(SiR¹R²O)ₘ—H+HO—(SiR¹R²O)ₙ—H→HO—(SiR¹R²O)ₘ₊ₙ—H+H₂O

In this schematic reaction, R¹ and R² represent substituted or unsubstituted hydrocarbon groups and may be the same or different. Furthermore, hydroxy-terminated siloxanes with different organic groups may be reacted together in this fashion, to produce a block copolymer.

In another example, discussed for instance in U.S. Pat. No. 6,727,337, U.S. Pat. No. 6,818,721 and U.S. Pat. No. 6,984,483, each of which is incorporated by reference in its entirety, the condensation reaction may be between an organically modified silanediol such as diphenylsilanediol and an organically modified trialkoxysilane, represented by the following scheme:

nAr₂Si(OH)₂+nRSi(OR′)₃→Organosilicon condensate+2nR′OH

In this scheme, each silicon atom is theoretically capable of being either di-branched (from the silane diol) or tri-branched (from the trialkoxysilane), although in reality, steric influences mean that most silicon atoms are di-branched (so that the organosilicon condensate is a linear polysiloxane), with a number of Si—OR′ groups remaining in the product polysiloxane.

These condensation reactions are of particular interest because of the physical properties of the condensates generally and because they allow functionality to be introduced into the polysiloxane by substitution on the silicon-bonded organic groups.

However, one weakness of the approach has been the nature of the catalyst required to carry out the condensation to form the polysiloxane backbone. A variety of catalysts have been employed for condensation reactions including, for example, sulfuric acid, hydrochloric acid, Lewis acids, sodium or potassium hydroxide and tetramethylammonium hydroxide. These catalysts can be chemically severe and when involved in the condensation of silanols with alkoxysilanes have been found to cause bond scission and random rearrangement. This problem was addressed, for example, in GB 918823, which provided condensation catalysts for the production of organosilicon compounds without siloxane bond scission and rearrangement.

The solution provided by GB 918823 is, however, not entirely satisfactory from the point of view of polymer optical materials. GB 918823 discloses the use of amine salts of phosphoric or carboxylic acids as condensation catalysts. While these may promote condensation without rearrangement, they are inherently unsuitable for use in the production of optical materials because they are usually liquids and/or are not readily removable from the product. The use of these compounds as catalysts for polymers in optical applications is also further hindered because they degrade at high temperatures, so any residual catalyst remaining within the polymer matrix would degrade during possible subsequent heat treatment.

The production of optical materials based on organosilicon compounds requires that the chemical structure of the components be well known and controlled. To achieve high optical performance, the structures need good reproducibility and predictability. Further, fine-tuning of the physical properties by chemical modification requires very precise control of the chemical structure and also precise control over other components that may remain in the material as artifacts of production. From this point of view, not only must random rearrangements within the polymer be kept to a minimum, but also large residual amounts of catalyst or catalyst degradation product are clearly unacceptable. For this reason, it is advantageous to use a solid catalyst that can be readily removed from the product polymer by filtration.

Solid catalysts are disclosed for example in U.S. Pat. No. 5,109,093, U.S. Pat. No. 5,109,094 and U.S. Pat. No. 6,818,721, each of which is incorporated by reference in its entirety. The '094 patent discusses the synthesis of siloxane polymers from the condensation of silanols (or via the self condensation of a silanediol or a hydroxy-terminated polysiloxane) via the use of magnesium, calcium, strontium and barium hydroxides, while the '093 patent, by the same inventors, discusses the synthesis of siloxane polymers from a condensation of a silanol and an alkoxysilane, but stipulates that the reaction proceeds only in the presence of barium hydroxide or strontium hydroxide. This narrower range of catalysts suggests that the reaction of alkoxysilanes with silanol containing compounds is more catalyst sensitive than the reaction of two silanol containing compounds. In the '721 patent it was shown that certain magnesium and calcium catalysts could in fact be used to catalyse the silanol plus alkoxysilane condensation reaction, provided a protic solvent was also present. In a preferred embodiment, the protic solvent was the same as the alcohol by-product of the condensation reaction, therefore necessitating no additional product purification steps.

However the abovementioned catalysts are still not ideal for producing siloxane polymers by condensation reactions. It is always desirable to reduce reaction times and temperatures, especially if the compounds involve contain temperature-sensitive moieties. Further, it is highly desirable to achieve greater control over product viscosity. For the linear siloxane polymers characteristically produced in condensation reactions, viscosity is closely correlated with chain length. It will be understood by those skilled in the art that a lack of catalyst activity can lead to shorter chain length, lower viscosity, and higher volatility. To some extent this lack of activity can be offset by using more catalyst, but this has cost disadvantages: because more catalyst is used, the filters used to remove the catalyst from the product polymer tend to block sooner and have a shorter useful life. There exists then a need for an alternative catalyst system with higher activity.

### SUMMARY OF THE INVENTION

According to a first aspect, the invention provides a process for the preparation of an organosilicon condensate comprising reacting together:

at least one silicon containing compound (A) having at least one silanol group; and
at least one silicon containing compound (B) having at least one silicon bonded —OX group;
wherein X represents hydrogen, an alkyl group having from 1 to 8 carbon atoms, or an alkoxyalkyl group having from 2 to 8 carbon atoms in the presence of
a catalyst selected from a group comprising strontium oxide, barium oxide, strontium hydroxide, barium hydroxide, and mixtures thereof, and at least one solvent selected to allow the reaction to proceed.

The organosilicon condensate is preferably a siloxane, and more preferably a polysiloxane. Compounds (A) and (B) may independently be monomeric, dimeric, oligomeric or polymeric compounds, and may be the same compound if X represents hydrogen.

In one preferred embodiment, X represents an alkyl group having from 1 to 8 carbon atoms, or an alkoxyalkyl group having from 2 to 8 carbon atoms. Preferably, the at least one silicon containing compound (A) is a silanol having between one and three unsubstituted or substituted hydrocarbon groups having from 1 to 18 carbon atoms, or alternatively may be described as a silanol with between one and four OH groups. A silanol with four OH groups is, in its simplest form silicic acid.

The silanol may also comprise a crosslinkable group, for example, a double bond of the acrylate, methacrylate or styrene type. Another suitable crosslinkable group is an epoxide group. Aryl substituted silanols are preferred. Particularly preferred silanols are diphenyl silanediol, 4-vinyl-diphenyl silanediol and dipentafluorophenyl silanediol.

Compound (A) may also be a polysiloxane such as a hydroxy-terminated polydimethylsiloxane (hydroxy-terminated PDMS). Preferably, the at least one silicon containing compound (B) is a monomeric compound with the general formula

G_{y}Si(OR)_{4-y}

wherein y has a value of 0, 1, 2 or 3,

G represents a unsubstituted or substituted hydrocarbon group having from 1 to 18 carbon atoms; and R represents an alkyl group having from 1 to 8 carbon atoms or an alkoxyalkyl group having from 2 to 8 carbon atoms.

Preferably, the at least one silicon containing compound (B) is an alkoxysilane, which has from one to four alkoxy groups inclusive. Preferably, the alkoxy group (OR) is selected from the group comprising methoxy, ethoxy, n-propoxy, i-propoxy, n-butoxy, i-butoxy, s-butoxy and t-butoxy.

Like the silanol, the alkoxysilane may also comprise a crosslinkable group, for example, a double bond of the acrylate, methacrylate or styrene type. Another suitable crosslinkable group is an epoxide group. Preferably, the crosslinkable group is on G, but it may be on R.

Trialkoxysilanes are a preferred form of alkoxysilanes. Trimethoxysilanes and triethoxysilanes are preferred, with trimethoxysilanes particularly preferred on grounds of higher reactivity. Preferred alkoxysilanes include propyltrimethoxysilane, hexyltrimethoxysilane, octyltrimethoxysilane, decyltrimethoxysilane, dodecyltrimethoxysilane, hexadecyltrimethoxysilane, vinyltrimethoxysilane, phenyltrimethoxysilane, phenylethyltrimethoxysilane, phenylpropyltrimethoxysilane, 3,3,3-trifluoro-propyltrimethoxysilane, nonafluoro-1,1,2,2-tetrahydrohexyl-trimethoxysilane, tridecafluoro-1,1,2,2-tetrahydrooctyl-trimethoxysilane, 3-methacryloxypropyltrimethoxysilane, 3-acryloxypropyltrimethoxysilane, 3-styrylpropyltrimethoxysilane and 3-glycidoxypropyltrimethoxysilane.

Alternatively, the at least one silicon containing compound (B) may be an oligomeric or polymeric compound of general formula

R¹₃SiO(SiR¹₂O)ₙSiR¹₂OR

wherein R is as defined above, n is an integer ≧0, and each R¹ may independently be G (as defined above), an alkoxy group having from 1 to 8 carbon atoms, an alkoxyalkyl group having from 2 to 8 carbon atoms, or an unsubstituted or substituted hydrocarbon group having from 1 to 18 carbon atoms. (B) may be for example a methoxy-terminated polydimethylsiloxane (methoxy-terminated PDMS).

In another preferred embodiment, X represents hydrogen, in which case compounds (A) and (B) are preferably each hydroxy-terminated siloxanes of general formula

HO—(SiR¹R²O)ₙ—H

wherein n is an integer >0, and R¹ and R² represent unsubstituted or substituted hydrocarbon groups having from 1 to 18 carbon atoms and may be the same or different. Alternatively, compound (A) or compound (B) may be a monomeric silane compound. Non-limiting examples of monomeric silanes include compounds such as diphenyl silanediol, 4-vinyl-diphenyl silanediol or dipentafluorophenyl silanediol.

The at least one solvent may be a protic solvent, for example an alcohol such as methanol, ethanol, 1-propanol, 2-propanol, 1-butanol and 2-butanol. Another protic solvent is water. Other suitable protic solvents include glycols such as ethylene glycol, polyols such as glycerol, alkoxyalcohols such as 2-methoxyethanol as well as phenol and substituted phenols. Alternatively, the at least one solvent may be a non-protic solvent, for example acetone or toluene. Preferably, the solvent will be the same as the by-product of the condensation reaction, i.e. XOH, which will be an alcohol or water depending on the identity of X. The term solvent as used herein encompasses single component systems and multiple component systems, for example a mixture of a protic solvent and a non-protic solvent in any varying amounts. Preferably, the solvent is selected to be readily removed once the reaction is completed, under conditions that do not lead to cross-linking of the organosilicon condensate. For example, it is preferable that any solvent used be removable by distillation under reduced pressure at a reasonable temperature, say 90° C. or less.

According to a second aspect, the invention provides a process for the preparation of an organosilicon condensate that comprises condensing at least one silicon containing compound having:
(a) at least one silanol group; and
(b) at least one —OX group
   wherein X represents one or more of hydrogen, an alkyl group having from 1 to 8 carbon atoms, or an alkoxyalkyl group having from 2 to 8 carbon atoms in the presence of
(c) a catalyst selected from the group comprising strontium oxide, barium oxide, strontium hydroxide, barium hydroxide and mixtures thereof; and
(d) at least one solvent selected to allow the reaction to proceed.

In one embodiment, X represents an alkyl group having from 1 to 8 carbon atoms or an alkoxyalkyl group having from 2 to 8 carbon atoms. In a second embodiment, X represents hydrogen. Those skilled in the art will recognise this as an intra-molecular version of the reaction according to the first aspect of the present invention. Those skilled in the art will recognise that any combination of inter- and intra-molecular condensations are contemplated by the present invention. It is also contemplated that combinations of crosslinkable and non-crosslinkable monomers or oligomers may be used, as well as non-identical monomers. Other reactions may also take place in the condensations of the present invention.

For example, the reactions of the present invention may also include a silicon containing compound comprising only one silanol group or only one silicon-bonded alkoxy group. Examples of such compounds are Me₃—(SiMe₂O)ₙ—H and Me₃—(SiMe₂O)ₙ—Me, wherein Me represents a methyl group. Those skilled in the art will recognise such compounds as end-capping species that can be useful for terminating the condensation polymerisation reaction.

The at least one solvent may be a protic solvent, for example an alcohol or water. Alternatively, the at least one solvent may be a non-protic solvent, for example acetone or toluene. Preferably, the solvent will be the same as the by-product of the condensation reaction, ie XOH, which will be an alcohol or water depending on the identity of X.

According to a third aspect, the invention provides a process for the preparation of an organosilicon condensate that comprises reacting together:
(A) at least one silicon containing compound having at least one silanol group; and
(B) at least one silicon containing compound having at least one silicon bonded —OX group, wherein X represents hydrogen, an alkyl group having from 1 to 8 carbon atoms, or an alkoxyalkyl group having from 2 to 8 carbon atoms in the presence of
(C) a catalyst selected from the group comprising strontium oxide, barium oxide, strontium hydroxide, barium hydroxide and mixtures thereof.
   Preferably, the catalyst is selected from the group comprising strontium oxide and barium oxide. Preferably, the reaction is performed in the presence of at least one solvent that promotes the activity of the catalyst or acts as a co-catalyst. The at least one solvent may be a protic solvent, for example an alcohol or water. Alternatively, the at least one solvent may be a non-protic solvent, for example acetone or toluene. Preferably, the solvent will be the same as the by-product of the condensation reaction, i.e. XOH, which may be an alcohol or water depending on the identity of X.

According to a fourth aspect, the invention provides a process for the preparation of an organosilicon condensate that comprises reaction steps comprising at least condensing at least one silicon containing compound having:
(a) at least one silanol group; and
(b) at least one —OX group, wherein X represents hydrogen, an alkyl group having from 1 to 8 carbon atoms, or an alkoxyalkyl group having from 2 to 8 carbon atoms in the presence of
(c) a catalyst selected from the group comprising strontium oxide, barium oxide, strontium hydroxide, barium hydroxide and mixtures thereof.
   Preferably, the catalyst is selected from the group comprising strontium oxide and barium oxide.

In one embodiment, X represents an alkyl group having from 1 to 8 carbon atoms or an alkoxyalkyl group having from 2 to 8 carbon atoms. In a second embodiment, X represents hydrogen. Those skilled in the art will recognise this as an intra-molecular version of the reaction according to the third aspect of the present invention. Preferably, the reaction is performed in the presence of at least one solvent that promotes the activity of the catalyst or acts as a co-catalyst. The at least one solvent may be a protic solvent, for example an alcohol or water. Alternatively, the at least one solvent may be a non-protic solvent, for example acetone or toluene. Preferably, the solvent will be the same as the by-product of the condensation reaction, ie XOH, which will be an alcohol or water depending on the identity of X.

The aspects of the invention share a number of preferred embodiments. The catalyst may be employed in an amount of from 0.0005 to 5% by mole ratio based on the total silicon containing compounds, and more preferably in an amount of from 0.01 to 0.5% by mole ratio based on the total silicon containing compounds.

The solvent or solvents, if present, may preferably be employed in an amount of from 0.02% to 200% by mole ratio based on the total silicon containing compounds. More preferably they are employed in an amount of 0.2% to 100% by mole ratio based on the total silicon containing compounds, and even more preferably in an amount of 0.4% to 50% by mole ratio based on the total silicon containing compounds.

In certain preferred embodiments, particularly where water is used as a solvent, it is preferably employed in amounts less than 8% by mole ratio based on the total silicon containing compounds, and more preferably less than 4% by mole ratio based on the total silicon containing compounds.

The process of the present invention may be carried out at a temperature in the range from 40° C. to 150° C., more preferably from 50° C. to 100° C., and most preferably from 80° C. to 90° C. It is particularly preferred that if a crosslinkable group is present, the reaction is carried out at a temperature below that at which crosslinking will compete with condensation. In this regard, if crosslinkable groups are present, the reaction is preferably carried out at a temperature of 90° C. or less.

It will be appreciated by those skilled in the art that the condensation polymerisation reactions of the present invention produce a condensation by-product X—OH that generally needs to be removed; this by-product will be water if X represents hydrogen or an alcohol if X represents an alkyl group having from 1 to 8 carbon atoms or an alkoxyalkyl group having from 2 to 8 carbon atoms. The by-product may be readily removed under vacuum after the completion of the reaction or during the course of the reaction.

Preferably, the catalyst is separated from the product organosilicon condensate, for example by filtration.

According to a fifth aspect, the invention provides an organosilicon condensate, preferably a siloxane or polysiloxane, having a viscosity in the range 100-10,000 cP, preferably 500-5,000 cP, more preferably 1,000-4,000 cP, and most preferably 2,000-3,000 cP, when measured at a temperature of 20° C.

The organosilicon condensates of the present invention are preferably of formula (Y),

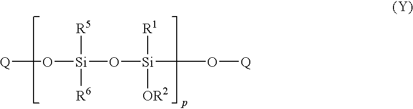

wherein R⁵ and R⁶ are independently alkyl, aralkyl or aryl groups comprising up to 20 carbon atoms;
R¹ and R² are independently alkyl, aralkyl or aryl groups;
Q is H or independently R² as defined above; and
p is at least 1.
Preferably, R⁵ and R⁶ are aralkyl or aryl groups comprising at least one aromatic or heteroaromatic ring. Preferably at least one of R¹, R², R⁵ or R⁶ comprises a cross-linkable functional group, which may be for example an epoxide group, a double bond of the acrylate type, a double bond of the methacrylate type or a double bond of the styrene type. One or all of R¹, R², R⁵ or R⁶ can vary with each repeating unit. In preferred condensates of formula Y, R⁵ and R⁶ are independently phenyl, 4-vinylphenyl or pentafluorophenyl.

Preferably, R¹ is methyl, ethyl, propyl, butyl, pentyl, hexyl, octyl, decyl, dodecyl, hexadecyl, vinyl, phenyl, phenylethyl, phenylpropyl, 3,3,3-trifluoro-propyl, nonafluoro-1,1,2,2-tetrahydrohexyl, tridecafluoro-1,1,2,2-tetrahydrooctyl, 3-methacryloxypropyl, 3-acryloxypropyl, 3-styrylpropyl or 3-glycidoxypropyl. Preferably, R² is methyl, ethyl, propyl, or butyl. The invention relates to all organosilicon condensates prepared according to the methods disclosed herein.

### DESCRIPTION OF FIGURES

The invention will now be described, by way of example only, with reference to the accompanying drawings in which:

FIGS. 1a and 1b show side and end views of a typical integrated optical waveguide.

FIGS. 2a to 2d illustrate a typical method of patterning a photo-curable polymer layer via photolithography and wet etching.

### DETAILED DESCRIPTION OF THE INVENTION

One embodiment of the invention provides a process for the preparation of an organosilicon condensate that comprises reacting together, in the presence of an alkaline earth catalyst: at least one silicon containing compound having at least one silanol group; and at least one silicon containing compound having at least one silicon bonded —OR group, where R represents an alkyl group having from 1 to 8 carbon atoms, or an alkoxyalkyl group having from 2 to 8 carbon atoms. The organosilicon condensate is a siloxane, and most preferably a polysiloxane. Both silicon containing compounds are preferably monomeric silanes (ie each contains only one silicon atom), but this need not be the case.

A reaction of specific interest is the polycondensation of silanediols with trialkoxysilanes or dialkoxysilanes, especially where either of the components comprises functionality for further cross-linking. The present invention allows for polycondensation reactions of the type disclosed for example in U.S. Pat. No. 6,727,337, U.S. Pat. No. 6,818,721 and U.S. Pat. No. 6,984,483, to produce storage stable, UV curable, NIR transparent, polycondensates by condensation of one or more silanediols of formula (I) and/or derived precondensates thereof

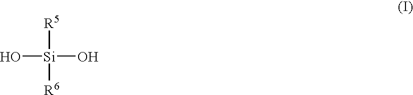

With one or more silanes of formula (II) and/or derived precondensates thereof

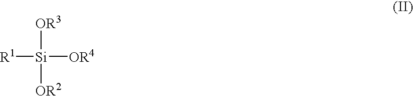

Alternatively, in place of compounds of formula (II), compounds such as R¹R²Si(OR³)(OR⁴) may be employed.

Preferably, R⁵ and R⁶ are each independently a group with up to 20 carbon atoms and at least one aromatic or heteroaromatic group, as disclosed for example in U.S. Pat. No. 6,727,337, U.S. Pat. No. 6,818,721 and U.S. Pat. No. 6,984,484. Alternatively, as disclosed in Australian patent application No AU 2003242399A1, incorporated herein by reference in its entirety, R⁵ and R⁶ may each independently be a sterically bulky non-aromatic group such as a tert-butyl, cyclopentyl or cyclohexyl group. R¹, R², R³ and R⁴ are independently alkyl, aralkyl or aryl or the like. Any of these groups may comprise crosslinkable functional groups and may be substituted in whole or in part, for example with halogen atoms.

The crosslinking functionalities may be for example carbon-carbon double bonds, such as in a styrene or acrylate (where they are more reactive because of conjugation, as compared with a simple vinyl substituent for example), or epoxide groups.

Those skilled in the art will appreciate that substitution of a hydrogen atom on any of the components by fluorine or some other halogen may take place to enhance the optical properties of the polycondensate and subsequently cured matrix. For example fluorination decreases the refractive index and reduces the attenuation of the polycondensate at wavelengths in the near IR that are useful for optical communications, while chlorination increases the refractive index and reduces the attenuation of the polycondensate at wavelengths in the near IR.

Other reactive species, such as —OH, —SH and —NH₂ may also be present on one or more of the substituents, to facilitate additional chemistry of the matrix, polycondensate, and oligomeric or monomeric species as desired. Combinations of non-crosslinkable and crosslinkable building blocks may also be used.

Similarly, some or all of the components may be replaced with co-condensable equivalents. For example, some or all of the compounds mentioned above may be replaced by one or more co-condensable compounds of boron or aluminium of general formula (III). These substitutions may have the advantage of increasing chemical stability and mechanical hardness.

a. M(OR″)₃ (III)

The groups R″ are identical or different, M signifies boron or aluminium and R″ represents an alkyl group with 1 to 4 carbon atoms. In the general formula (III), all three alkoxy groups can condense with compounds of general formula (I), so that only ⅔ of the molar quantity is required. Examples of compounds of general formula (III) are Al(OCH₃)₃, Al(OC₂H₅)₃, Al(O-n-C₃H₇)₃, Al(O-i-C₃H₇)₃, Al(O-n-C₄H₉)₃, Al(O-i-C₄H₉)₃, Al(O-s-C₄H₉)₃, B(O-n-C₄H₉)₃, B(O-t-C₄H₉)₃, B(O-n-C₃H₇)₃, B(O-i-C₃H₇)₃, B(OCH₃)₃ and B(OC₂H₅)₃.

Alternatively, some or all of R¹Si(OR)₃ or R¹₂Si(OR)₂ as the case may be can be replaced by one or more co-condensable compounds of silicon, germanium, titanium or zirconium of general formula (IV).

a. M′(OR″)₄ (IV)

The groups R″ are identical or different, M′ signifies silicon, germanium, titanium or zirconium and R″ represents an alkyl group with 1 to 4 carbon atoms. In the general formula (IV), all four alkoxy groups can condense with compounds of general formula (I), so two molecules of compound (II) may be replaced by one molecule of compound (IV). Examples of compounds of general formula (IV) include Si(OCH₃)₄, Si(OC₂H₅)₄, Si(O-n-C₃H₇)₄, Si(O-i-C₃H₇)₄, Si(O-n-C₄H₉)₄, Si(O-i-C₄H₉)₄, Si(O-s-C₄H₉)₄, Ge(OCH₃)₄, Ge(OC₂H₅)₄, Ge(O-n-C₃H₇)₄, Ge(O-i-C₃H₇)₄, Ge(O-n-C₄H₉)₄, Ge(O-i-C₄H₉)₄, Ge(O-s-C₄H₉)₄, Ti(OCH₃)₄, Ti(OC₂H₅)₄, Ti(O-n-C₃H₇)₄, Ti(O-i-C₃H₇)₄, Ti(O-n-C₄H₉)₄, Ti(O-i-C₄H₉)₄, Ti(O-s-C₄H₉)₄, Zr(OCH₃)₄, Zr(OC₂H₅)₄, Zr(O-n-C₃H₇)₄, Zr(O-i-C₃H₇)₄, Zr(O-n-C₄H₉)₄, Zr(O-i-C₄H₉)₄ and Zr(O-s-C₄H₉)₄.

By substituting the compounds of general formula (II) by compounds of general formula (III) or (IV), the refractive index and optical attenuation of the resultant polycondensate can be tuned to a specific application. For example alkyl-substituted components generally cause a reduction in refractive index and aryl-substituted components cause an increase in refractive index, while both will decrease the optical attenuation at some wavelengths and increase it at other wavelengths.

Other resins, oligomers, monomers, particulate matter or other functional material may be added to the reaction mixture to modify the physical (refractive index), mechanical (hardness, thermal expansion profile) or chemical (introduction of reactive moieties) properties of the resulting polycondensate. Product polycondensates may also be blended together to obtain desired optical properties.

As mentioned above, U.S. Pat. No. 5,109,093 discloses the synthesis of siloxanes from the condensation of a silanol and an alkoxysilane in the presence of a catalyst comprising barium hydroxide or strontium hydroxide. U.S. Pat. No. 5,109,094 on the other hand discloses the synthesis of siloxanes from the condensation of silanols (or via the self condensation of a hydroxy-terminated siloxane) in the presence of a catalyst comprising magnesium hydroxide, calcium hydroxide, strontium hydroxide and barium hydroxide. This suggests that the reaction of alkoxysilanes with silanol containing silicon compounds is more sensitive to the nature of the catalyst than the condensation of two silanol containing silicon compounds.

Thus, in combination, the teachings of U.S. Pat. No. 5,109,093 and U.S. Pat. No. 5,109,094 appear to suggest that attempts to condense a silanol and an alkoxysilane in the presence of a calcium or magnesium catalyst would at best lead to condensation of the silanol without reaction of the alkoxysilanes. Subsequently, U.S. Pat. No. 6,818,721 disclosed that a silanol-containing compound and an alkoxysilane could in fact be condensed in the presence of a calcium or magnesium catalyst such as calcium or magnesium hydroxide or oxide, provided a protic solvent was also present. Surprisingly, the condensation reaction could be made to proceed even when the protic solvent was identical to the condensation by-product (eg methanol). A protic solvent is defined as a solvent with at least one dissociable proton. Protic solvents are often considered to be weak acids, with the dissociable proton able to be abstracted by a sufficiently strong base.

There are many possible catalysts for the production of siloxane polymers, but the number of suitable catalysts is very often limited by the nature of the siloxane polymer and the application for which it is required. For example, an acidic catalyst is unlikely to be suitable for the production of siloxane polymers with basic functional groups such as aminopropyl groups. By way of illustration only, the requirements of a photo-curable siloxane polymer for the photo-patterning of fine features on a planar substrate will be considered in this specification, with a particular emphasis on optical waveguides.

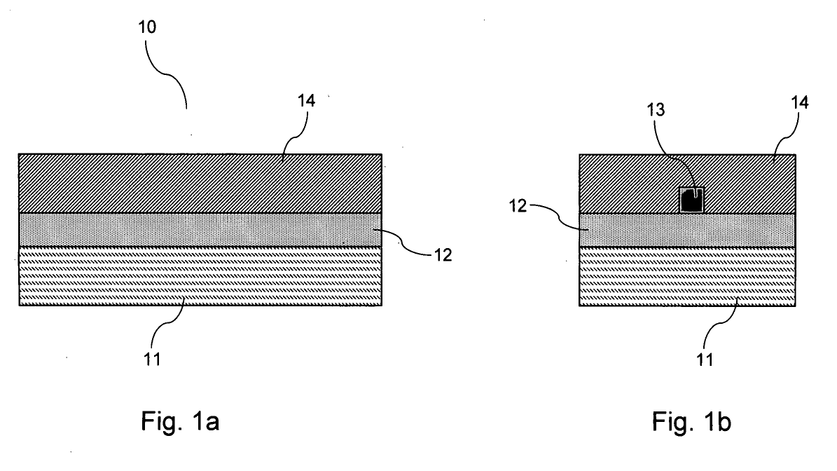

FIGS. 1a and 1b show side and end views of a typical integrated optical waveguide 10, comprising a substrate 11, a lower cladding layer 12, a light guiding core 13 and an upper cladding layer 14. The refractive index of the lower 12 and upper 14 cladding layers needs to be less than that of the core 13, so that light is confined within the core. Often, the lower 12 and upper 14 cladding layers have the same refractive index, so that the core-guided mode is symmetric, although this is not essential. If the substrate material is transparent and has refractive index lower than the core material, the lower cladding 12 may be omitted. Typically, waveguides have a light transmissive elongated core region that is square or rectangular in cross section, as illustrated in FIG. 1.

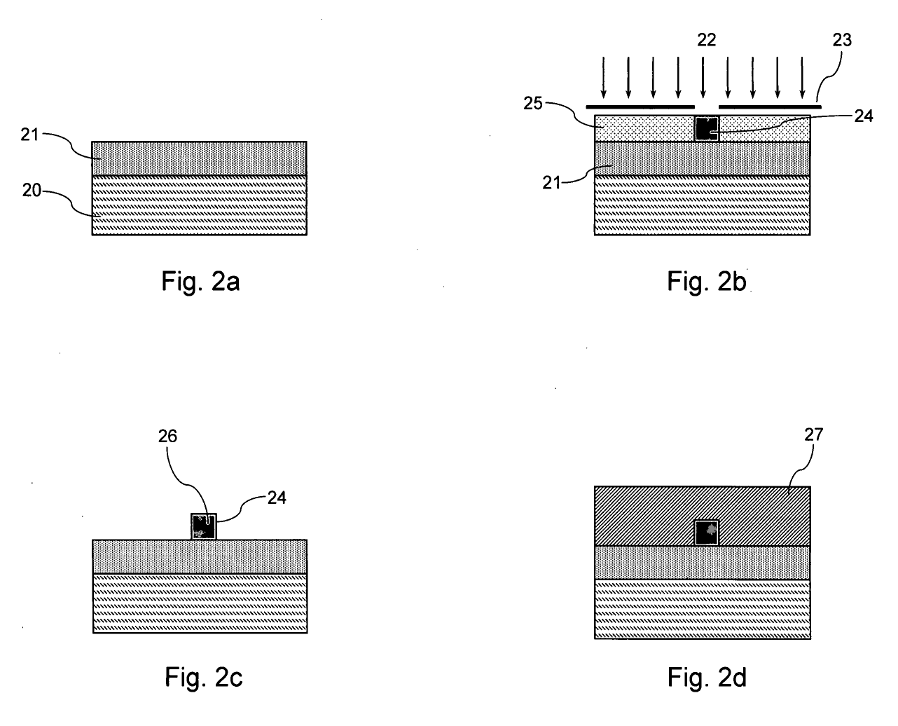

For certain optical waveguide applications, photo-patternable polymers are a particularly favourable material system, because the capital cost of the fabrication plant is considerably less than required for other waveguide materials such as silicate glass or silicon. The fabrication of optical waveguides from photo-patternable polymers is well known in the art, disclosed for example in U.S. Pat. No. 4,609,252, U.S. Pat. No. 6,054,253 and U.S. Pat. No. 6,555,288, each of which is incorporated by reference in its entirety, and typically involves deposition of a layer of a photo-curable liquid polymer or polymer solution onto a substrate, followed by image-wise exposure of the photo-curable polymer to light, usually ultraviolet (UV) light. The patterned polymer layer is then flushed with a developing solvent, exploiting a solubility differential between exposed and unexposed material. A typical procedure for fabricating an optical waveguide from UV-patternable polymers is illustrated in FIGS. 2a to 2d. As shown in FIG. 2a, a low refractive index UV-curable polymer is deposited onto substrate 20 and blanket exposed to UV light to form a lower cladding layer 21. As shown in FIG. 2b, a high refractive index UV-curable polymer is deposited onto lower cladding layer 21, then image-wise exposed to UV light 22 through a mask 23 to produce a region of UV-exposed material 24 and a region of unexposed material 25. FIG. 2c shows a core 26 comprised of UV-exposed material 24, after the unexposed material 25 has been removed with a solvent, in a step commonly known as “wet development” or “wet etching”. Finally, FIG. 2d shows an upper cladding layer 27 formed by deposition and blanket UV exposure of another low refractive index UV-curable polymer. The image-wise exposure could alternatively be performed by a laser direct writing procedure, although exposure through a mask is generally preferred for high fabrication throughput.

It will be appreciated that two key requirements for the polymer waveguide fabrication process shown in FIGS. 2a to 2d are: the provision of photo-crosslinkable functions on the polymer; and the ability to deposit optical quality (ie extremely smooth and uniform) layers of polymer material.

Considering firstly those cases where there is a requirement for the polymer to have photo-crosslinkable functions, it will be appreciated by those skilled in the art that suitable functional groups, such as methacrylate, acrylate and styrene, are also thermally sensitive, and should not be exposed to excessively high temperatures. Therefore when synthesising a photo-patternable polymer material, it is clearly desirable to perform the reaction at as low a temperature as possible. In the case of the alkaline earth hydroxide catalysts disclosed in U.S. Pat. No. 5,109,093 and U.S. Pat. No. 5,109,094, all exemplified reactions required temperatures of 100° C. or more. On the other hand, the exemplified reactions using the calcium or magnesium catalyst/protic solvent system disclosed in U.S. Pat. No. 6,818,721 were all performed at 80° C., which is clearly preferable when the polymers contain crosslinkable functional groups. Similarly, all catalyst systems of the present invention are active at temperatures at or below 100° C., preferably at or below 90° C., and most preferably at or below 80° C.

Depositing optical quality layers is a process best done from the liquid phase. Several liquid phase techniques for depositing polymer layers are known in the art, including spin coating, dip coating, extrusion coating, slot coating, roller coating, meniscus coating, spray coating, curtain coating and doctor blading; spin coating is generally considered to be the method of choice for depositing optical quality layers, which are typically 5 to 50 μm in thickness. It will be appreciated that there is an acceptable range of viscosity for forming a high quality layer by spin coating: if the material is too viscous it will not spread out properly; and if it is not viscous enough it will tend to fly off the substrate without forming a uniform layer. For spin coating, a material preferably has a viscosity in the range 100-10,000 cP, more preferably in the range 500-5,000 cP, even more preferably in the range 1,000-4,000 cP, and most preferably in the range 2,000-3,000 cP.

Siloxane polymers prepared by the process of the present invention are generally intrinsically viscous liquids that, unlike most optical polymers that are solids, do not require the addition of a solvent for liquid phase coating. The advantages of solvent-free polymers for the spin coating of optical quality layers are known in the art (L. Eldada and L. W. Shacklette, IEEE Journal of Selected Topics in Quantum Electronics vol. 6, pp. 54-68, 2000; U.S. provisional patent application No. 60/796,667 entitled ‘Low volatility polymers for two-stage deposition processes’ and incorporated by reference in its entirety). As discussed in the aforementioned US provisional patent application, in many photolithography tools the substrate and mask are mounted in a vertical or near-vertical configuration, to prevent gravity-induced sagging of the mask or substrate. This imposes another constraint on the viscosity of solvent-free polymers (that remain liquid prior to UV exposure), since if the viscosity is too low the material will flow when the substrate is held vertically, resulting in variable thickness. Fortunately, the required viscosity range is similar to that required for producing optical quality layers in the first place, ie 100-10,000 cP, preferably 500-5,000 cP, more preferably 1,000-4,000 cP, and most preferably 2,000-3,000 cP.

In this discussion of preferred viscosity ranges, it will be appreciated that if an otherwise solvent-free polymer is too viscous, it can be thinned by one of the many solvents known in the art of spin coating, although as mentioned above it is preferable not to include a solvent. On the other hand, if the solvent-free polymer is insufficiently viscous, there is little that can be done apart from cooling the polymer and/or the lab as a whole, which is generally impractical. It will be appreciated by those skilled in the art that for a given type of (liquid) polymer, a lower viscosity is generally associated with a higher volatility, because of the presence of low molecular weight components. These components may act as a de facto solvent, such that the polymer could not be considered to be ‘solvent-free’ for the purposes of spin coating.

While the catalyst system of U.S. Pat. No. 6,818,721 catalyses the condensation polymerisation of siloxanes at moderate temperatures around 80° C., a stronger catalyst system is still desirable, to expand the range of siloxane polymers that can be produced with an appropriate viscosity.

The siloxane polymers prepared using the catalyst systems of the present invention are highly transparent throughout the visible and near infrared regions, including the wavelengths of 1310 nm and 1550 nm of importance for telecommunications. Further, they can be made UV curable and photo-patternable in layers of thickness up to 150 μm without loss of quality, making them suitable for application as photoresists, negative resists, dielectrics, light guides, transparent materials, or as photo-structurable materials.

It is also possible to add further polymerisable components (monomers, oligomers or polymers) before curing, for example acrylates, methacrylates or styrene compounds (to space polymer chains), where the polymerisation proceeds across the C═C double bonds, or compounds containing ring systems that are polymerisable by cationic ring opening.

Photoinitiators or thermal initiators may be added to increase the rate of curing. Commercially available photoinitiators include 1-hydroxycyclohexylphenyl ketone, benzophenone, 2-chlorothioxanthone, 2-methylthioxanthone, 2-iso-propylthioxanthone, benzoin, 4,4′-dimethoxybenzoin etc. For curing with visible light, the initiator may be for example camphorquinone.

For thermal initiators, organic peroxides in the form of peroxides (e.g. dibenzoyl peroxide), peroxydicarbonates, peresters (t-butyl perbenzoate), perketals, hydroperoxides may also be used. AIBN (azobisisobutyronitrile) may also be used. Radiation cure, for example by gamma rays or electron beam, is also possible.

Other additives, such as stabilisers, plasticisers, contrast enhancers, dyes or fillers may be added to enhance the properties of the polycondensate as required. For example, stabilisers to prevent or reduce degradation, which leads to property deterioration such as cracking, delamination or yellowing during storage or operation at elevated temperature, are advantageous additives.

Such stabilisers include UV absorbers, light stabilisers, and antioxidants. UV absorbers include hydroxyphenyl benzotriazoles, such as 2-[2-hydroxy-3,5-di(1,1-dimethylbenzyl)phenyl]-2-H-benzotriazole (Tinuvin 900), poly(oxy-1,2-ethanediyl), α-(3-(3-(2H-benzyotriazol-2-yl)-5-(1,1-dimethylethyl)-4-hydroxyphenyl)-1-oxopropyl)-co-hydroxy (Tinuvin 1130), and 2-[2-hydroxy-3,5-di(1,1-dimethylpropyl)phenyl]-2-H-benzotriazole (Tinuvin 238), and hydroxybenzophenones, such as 4-methoxy-2-hydroxybenzophenone and 4-n-octoxy-2-hydrox benzophenone. Light stabilisers include hindered amines such as 4-hydroxy-2,2,6,6-tetramethylpiperidine, 4-hydroxy-1,2,2,6,6-pentamethylpiperidine, 4-benzoyloxy-2,2,6,6-tetramethylpiperidine, bis(2,2,6,6-tetramethyl-4-piperidinyl)sebacate (Tinuvin 770), bis(1,2,2,6,6-pentamethyl-4-piperidinyl)sebacate (Tinuvin 292), bis(1,2,2,6,6-pentamethyl-4-piperidinyl)-2-n-butyl-2-(3,5-di-tert-butyl-4-hydroxybenzyl)malonate (Tinuvin 144), and a polyester of succinic acid with N-β-hydroxy-ethyl-2,2,6,6-tetramethyl-4-hydroxy-piperidine (Tinuvin 622). Antioxidants include substituted phenols such as 1,3,5-trimethyl-2,4,6-tris(3,5-di-tert-butyl)-4-hydroxybenzyl)benzene, 1,1,3-tris-(2-methyl-4-hydroxy-5-tert-butyl)phenyl)butane, 4,4′-butylidene-bis-(6-tert-butyl-3-methyl)phenol, 4,4′-thiobis-(6-tert-butyl-3-methyl)phenol, tris-(3,5-di-tert-butyl-4-hydroxybenzyl)isocyanurate, cetyl-3,5-di-tert-butyl-4-hydroxybenzene (Cyasorb UV2908), 3,5-di-tert-butyl-4-hydroxybenzoic acid, 1,3,5-tris-(tert-butyl-3-hydroxy-2,6-dimethylbenzyl) (Cyasorb 1790), stearyl-3-(3,5-di-tert-butyl-4-hydroxyphenyl)propionate (Irganox 1076), pentaerythritol tetrabis(3,5-di-tert-butyl-4-hydroxyphenyl) (Irganox 1010), and thiodiethylene-bis-(3,5-di-tert-butyl-4-hydroxy)hydrocinnamate (Irganox 1035).

The invention will now be demonstrated by a series of non-limiting examples. Examples 1 to 34 concern the synthesis of siloxane polymers via an Si—OH+RO—Si condensation reaction, Example 35 demonstrates the use of such polymers in the fabrication of optical waveguides, and Examples 36-43 concern the synthesis of siloxane polymers via an Si—OH+HO—Si condensation reaction. Finally, Example 44 demonstrates that the Si—OH+RO—Si condensation reaction is not unique to our preferred silanol-containing silicon compound.

### EXAMPLES 1-12

A number of examples are shown in Table 1, all relating to the production of a siloxane polymer material from a 1:1 (by mole) mixture of diphenyl silanediol (DPS, molecular mass 216.3, structure V) and 3-methacryloxypropyltrimethoxysilane (MPS, molecular mass 248.4, structure VI). The product polymer is crosslinkable via the methacrylate functionality.

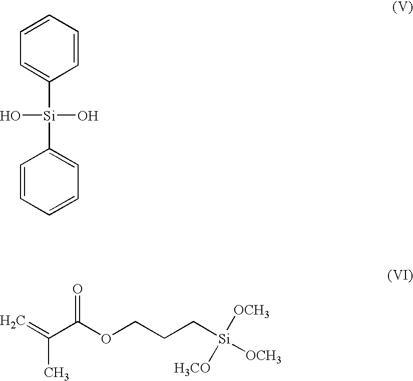

### General Procedure:

DPS and MPS were mixed and heated to 80° C. for 30 min. Catalyst (and solvent if required) was added and the mixture maintained at 80° C. for 1 hr, with the reaction time (defined as the time taken for the reaction mixture to turn clear after the catalyst (and solvent if required) had been added) recorded. Note that since DPS is a white powdery solid, the reaction time is easy to determine. If the reaction mixture did not turn clear after 1 hour, the system was labelled ‘no reaction’. If a reaction did occur, the methanol (co-catalyst and condensation by-product) was removed by distillation at 80° C. under reduced pressure, then the product resin was filtered through a 0.2 μm filter to remove the insoluble catalyst. The viscosity was measured at 20° C. on a Brookfield DV-II+ RV with a small sample adaptor.

TABLE 1

| | | | | | | Solvent | Reaction | Product |
|---|---|---|---|---|---|---|---|---|
| | DPS | MPS | | Catalyst | | level | time | Viscosity |
| Example | (g) | (g) | Catalyst | Level | Solvent | (%) | (min:s) | (cP) |
| 1 | 20.38 | 24.45 | SrO | 0.075 | — | — | No reaction | — |
| 2 | 20.20 | 23.20 | BaO | 0.075 | — | — | No reaction | — |
| 3 | 20.90 | 24.07 | Sr(OH)₂ | 0.075 | — | — | No reaction | — |
| 4 | 20.22 | 23.29 | Ba(OH)₂ | 0.075 | — | — | 10:00 | 2,665 |
| 5 | 21.15 | 24.30 | SrO | 0.10 | Methanol | 40 | 4:20 | 2,800 |
| 6 | 20.88 | 24.01 | BaO | 0.10 | Methanol | 40 | 1:20 | 3,490 |
| 7 | 20.95 | 24.06 | Sr(OH)₂ | 0.075 | Methanol | 40 | 21:30 | 1,810 |
| 8 | 21.31 | 24.49 | Ba(OH)₂ | 0.10 | Methanol | 40 | 2:50 | 2,690 |
| 9 | 32.70 | 37.55 | CaO | 0.25 | — | — | No reaction | — |
| 10 | 36.75 | 43.00 | Ca(OH)₂ | 0.10 | — | — | No reaction | — |
| 11 | 20.54 | 23.60 | CaO | 0.25 | Methanol | 40 | 52:00 | 3,310 |
| 12 | 47.75 | 54.87 | Ca(OH)₂ | 0.15 | Methanol | 40 | 36:30 | 1,505 |

DPS: diphenyl silanediol
MPS: 3-methacryloxypropyltrimethoxysilane
Catalyst level: mol % with respect to total silicon-containing compounds (ie DPS plus MPS)
Solvent level: mol % with respect to total silicon-containing compounds (ie DPS plus MPS)
Viscosity: measured in centipoise at 20.0° C.

Examples 1 to 4 show that, in the absence of methanol, the reaction between DPS and MPS only proceeded (at 80° C.) when barium hydroxide was used as the catalyst. U.S. Pat. No. 5,109,093, in particular examples 2 and 5 therein, suggests that strontium hydroxide may be an effective catalyst for this reaction at 120° C., but this is an undesirably high temperature for a siloxane polymer containing crosslinkable groups. In comparison, Examples 5 to 7 show that the other catalysts (strontium oxide, barium oxide and strontium hydroxide) are effective at 80° C. if methanol (a protic solvent) is included as a catalyst promoter or co-catalyst. Furthermore, comparison of Examples 4 and 8 shows that the barium hydroxide catalysed reaction is accelerated by the addition of methanol as a catalyst promoter or co-catalyst. Examples 9 to 12, repeating material disclosed in U.S. Pat. No. 6,818,721, show that calcium oxide and calcium hydroxide are, like most of the other catalysts, only effective if methanol is included as a co-solvent.

It must be stressed that the observed promoter/co-catalytic effect of methanol is a surprising result, given that methanol is a by-product of the condensation polymerisation reaction. Ordinarily, one would expect that the addition of a product to a reaction mixture would, if anything, reduce the reaction rate.

### EXAMPLES 13-19

In each of the above Examples 1-12, the solvent (if present) was always methanol. Following the same general procedure as for Examples 1-12, the efficacy of several other solvents was investigated in a second set of examples also based on the reaction between DPS and MPS, shown in Table 2.

TABLE 2

| | | | | | | Solvent | Reaction | Product |
|---|---|---|---|---|---|---|---|---|
| | DPS | MPS | | Catalyst | | level | time | Viscosity |
| Example | (g) | (g) | Catalyst | Level | Solvent | (%) | (min:s) | (cP) |
| 13 | 19.96 | 22.95 | BaO | 0.10 | Ethanol | 40 | 1:20 | 7,050 |
| 14 | 21.78 | 25.03 | BaO | 0.10 | Water | 5 | 1:15 | 8,070 |
| 15 | 21.38 | 24.58 | BaO | 0.10 | Acetone | 40 | 1:10 | 3,280 |
| 16 | 21.08 | 24.25 | BaO | 0.10 | Toluene | 40 | 1:10 | 5,775 |
| 17 | 22.76 | 26.12 | Sr(OH)₂ | 0.10 | Acetone | 40 | No reaction | — |
| 18 | 22.94 | 26.40 | SrO | 0.10 | Acetone | 40 | 9:00 | 3,375 |
| 19 | 21.50 | 24.75 | SrO | 0.10 | Toluene | 40 | No reaction | — |

DPS: diphenyl silanediol
MPS: 3-methacryloxypropyltrimethoxysilane
Catalyst level: mol % with respect to total silicon-containing compounds (ie DPS plus MPS)
Solvent level: mol % with respect to total silicon-containing compounds (ie DPS plus MPS)
Viscosity: measured in centipoise at 20.0° C.

Examples 13-16, together with Example 6, show that for the relatively strong catalyst BaO, a wide range of solvents can be used to promote the condensation reaction, including the non-protic solvents acetone and toluene. Water is a particularly effective promoter/co-catalyst, with a relatively small amount (eight drops in the specific case of Example 14) contributing to the highest product viscosity for any of Examples 1-19. Non-protic solvents (acetone and toluene) were less effective with the weaker strontium-based catalysts, in keeping with the result from U.S. Pat. No. 6,818,721 that non-protic solvents were never effective with the even weaker calcium-based catalysts. It can also be seen from Examples 6 and 13-16 that the product viscosity depends on the solvent used. The solvent can be chosen according to considerations of promoter/co-catalytic activity, product viscosity and ease of removal from the siloxane polymer product. All other things being equal, methanol is to be preferred in these reactions since it is also the condensation by-product, readily removed from the product.

The set of Examples in Table 2 also rules out the possibility that the added solvent is promoting the reaction between DPS (a solid) and MPS (a liquid) simply by dissolving some or all of the DPS. Acetone is a much better solvent for DPS than methanol or ethanol but is a less effective promoter/co-catalyst, and water is a very effective promoter/co-catalyst despite DPS being insoluble in water.

The following examples illustrate the formation of polymers from a silanediol and a mixture of alkoxysilanes.

### EXAMPLES 20-33

A third set of examples is shown in Table 3, relating to the production of a siloxane polymer material from a 2:1:1 (by mole) mixture of DPS (structure V), MPS (structure VI) and octyltrimethoxysilane (OMS, molecular weight 234.41, structure VII), with the product polymer again crosslinkable via the methacrylate functionality. In each of these examples, DPS, OMS and MPS were mixed and heated to 80° C. for 30 min, and the reaction procedure continued as per Examples 1-12.

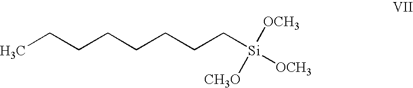

TABLE 3

| | | | | | | | Solvent | Reaction | Product |
|---|---|---|---|---|---|---|---|---|---|
| | DPS | OMS | MPS | | Catalyst | | level | time | Viscosity |
| Example | (g) | (g) | (g) | Catalyst | Level | Solvent | (%) | (min:s) | (cP) |
| 20 | 21.04 | 11.46 | 12.10 | SrO | 0.20 | — | — | No reaction | — |
| 21 | 20.28 | 11.01 | 11.70 | BaO | 0.20 | — | — | 5:40 | 1,650 |
| 22 | 20.20 | 10.95 | 11.64 | Sr(OH)₂ | 0.20 | — | — | No reaction | — |
| 23 | 21.37 | 11.60 | 12.29 | Ba(OH)₂ | 0.20 | — | — | 1:20 | 3,290 |
| 24 | 21.09 | 11.44 | 12.15 | SrO | 0.20 | Methanol | 40 | 2:05 | 1,332 |
| 25 | 22.36 | 12.14 | 12.84 | BaO | 0.20 | Methanol | 40 | 0:30 | 1,780 |
| 26 | 21.27 | 11.58 | 12.23 | BaO | 0.40 | Methanol | 40 | 0:30 | 2,737 |
| 27 | 21.00 | 11.40 | 12.10 | Sr(OH)₂ | 0.20 | Methanol | 40 | 4:10 | 1,910 |
| 28 | 22.90 | 12.44 | 13.16 | Ba(OH)₂ | 0.20 | Methanol | 40 | 1:20 | 1,518 |
| 29 | 22.00 | 12.06 | 12.76 | CaO | 0.20 | — | — | No reaction | — |
| 30 | 20.82 | 11.29 | 11.97 | Ca(OH)₂ | 0.20 | — | — | No reaction | — |
| 31 | 20.30 | 11.05 | 11.68 | CaO | 0.20 | Methanol | 40 | 33:30 | 987 |
| 32 | 20.45 | 11.10 | 11.78 | CaO | 0.40 | Methanol | 40 | 18:20 | 1,213 |
| 33 | 21.82 | 11.84 | 12.54 | Ca(OH)₂ | 0.20 | Methanol | 40 | 14:30 | 802 |

DPS: diphenyl silanediol
OMS: octyl trimethoxysilane
MPS: 3-methacryloxypropyltrimethoxysilane
Catalyst level: mol % with respect to total silicon-containing compounds (ie DPS plus OMS plus MPS)
Solvent level: mol % with respect to total silicon-containing compounds (ie DPS plus OMS plus MPS)
Viscosity: measured in centipoise at 20.0° C.

Examples 20 to 23 and 29 to 30 show that in the absence of methanol, barium hydroxide is again the strongest of the catalysts tested, as for the reaction between DPS and MPS (Examples 1 to 4 and 9 to 10). Barium oxide was able to catalyse the reaction in the absence of methanol in this case, although a larger amount was used (compare Examples 21 and 2) and the product viscosity (1650 cP) was not particularly high. Examples 24 to 28 and 31 to 33 again show the surprising promoter/co-catalytic effect of methanol, and Examples 25, 26, 31 and 32 demonstrate that increasing the catalyst concentration increases the product viscosity (which is directly related to the length of the siloxane polymer chain). Once condensation reaches a certain point, accessibility to reactive sites becomes important so the condensation reaction becomes more dependent upon catalyst concentration. Larger amounts of catalyst are able to condense more SiOH and SiOR groups in the starting material, leading to a higher molecular weight and therefore a higher viscosity.

Significantly, Examples 31 to 33 show that although calcium oxide and calcium hydroxide can be activated as catalysts by the addition of the protic solvent methanol (as known from U.S. Pat. No. 6,818,721), the product viscosities are well short of the desired range of 2,000-3,000 cP for solventless spin coating. On the other hand, Examples 25 and 26 indicate that the barium oxide/methanol combination would be suitable for achieving a product viscosity in the range 2,000-3,000 cP, with a straightforward adjustment of the barium oxide concentration.

### EXAMPLE 34

This example describes the production of a siloxane polymer material from a 2:1:1 (by mole) mixture of DPS (structure V), MPS (structure VI) and 3,3,3-trifluoro-propyltrimethoxysilane (FPMS, molecular weight 218.28, structure VIII) with the product polymer again crosslinkable via the methacrylate functionality.

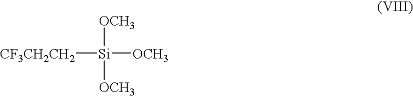

20.20 g DPS, 11.60 g MPS, and 10.19 g FPMS were mixed and heated to 80° C. for 30 min, then 0.40 mol % barium oxide and 80 mol % methanol (with respect to DPS) were added. The mixture became clear after 40 seconds, and was maintained at 80° C. for 1 hr, after which the methanol (promoter/co-catalyst and condensation by-product) was removed by distillation under reduced pressure. The resin was then filtered through a 0.2 μm filter to remove the barium oxide, and the viscosity at 20° C. measured to be 1980 cP.

### EXAMPLE 35

This example illustrates UV curing and UV patterning applications of the siloxane polymers synthesised using the inventive catalyst system, for producing an integrated optical waveguide according to the general procedure shown in FIGS. 2a to 2d. In this example, the product from Example 34 was used as the lower refractive index cladding material (designated polymer A), and the product from Example 26 was used as the higher refractive index core material (designated polymer B). The refractive index values of polymers A and B were measured on an Abbe refractometer (at 20° C.) to be 1.523 and 1.532 respectively. The free radical generating photoinitiator Irgacure 369 (Ciba Geigy) was added at a level of 2 wt % to both polymers A and B, and each polymer was filtered to 0.2 μm through a PTFE filter. A film of polymer A was spin coated at 1700 rpm for 45 secs onto a silicon wafer substrate, then cured with UV light from a mercury lamp in an Oriel flood illuminator to form a lower cladding layer 21. To form a core layer, a film of polymer B was spin coated at 2600 rpm for 60 seconds, then patterned by imagewise exposure to UV light through a mask in a Canon MPA500 photolithography tool. Unexposed polymer B material was then dissolved in isopropanol to leave the desired waveguide core pattern 26. An upper cladding layer 27 was then deposited in the same manner as the lower cladding layer, and the process completed with a blanket UV cure in the Oriel flood illuminator and a post bake at 170° C. for 3 hours under vacuum.

### EXAMPLES 36-43

A number of examples are shown in Table 4, all relating to the production of a siloxane polymer material from self-condensation of a hydroxy-terminated polydimethylsiloxane (PDMS, structure IX) fluid, obtained from Sigma Aldrich.

HO—[Si(CH₃)₂—O]ₘ—H (IX)

The PDMS fluid had a viscosity of 102 cP at 20° C., which correlates to an average molecular weight of approximately 1750, ie a polymer chain length of m ˜23.

### General Procedure:

The PDMS was heated to the reaction temperature (80° C. or 100° C.) for 30 min, then catalyst (and solvent if required) was added and the mixture maintained at the reaction temperature for 2 hr. The condensation by-product (water) and solvent (if present) were removed by distillation at 80° C. under reduced pressure, then the product resin was filtered through a 0.2 μm filter to remove the insoluble catalyst and the viscosity measured at 20° C. on a Brookfield DV-II+ RV with a small sample adaptor. If the product viscosity was within 10% of the PDMS starting material (ie less than 112 cP), the system was labelled ‘no reaction’.

TABLE 4

| | Reaction | | | Catalyst | | Solvent | Product |
|---|---|---|---|---|---|---|---|
| | temperature | PDMS | | amount | | amount | viscosity |
| Example | (° C.) | (g) | Catalyst | (g) | Solvent | (g) | (cP) |
| 36 | 100 | 20.00 | Sr(OH)₂ | 0.123 | — | — | No reaction |
| 37 | 100 | 20.03 | SrO | 0.207 | — | — | 120 |
| 38 | 100 | 20.01 | Ba(OH)₂ | 0.188 | — | — | 540 |
| 39 | 100 | 19.96 | Ba(OH)₂ | 0.406 | — | — | >25,000 |
| 40 | 100 | 20.02 | BaO | 0.078 | — | — | >25,000 |
| 41 | 80 | 20.40 | BaO | 0.076 | — | — | No reaction |
| 42 | 80 | 20.40 | BaO | 0.076 | methanol | 0.55 | 350 |
| 43 | 80 | 20.40 | BaO | 0.076 | water | 0.10 | 1,880 |

In keeping with U.S. Pat. No. 5,109,094, where most exemplified reactions (generally self-condensation of hydroxy-terminated PDMS, catalysed by alkaline earth hydroxides) were performed at 100 or 105° C., Examples 36 and 38 showed that barium hydroxide is a more effective catalyst than strontium hydroxide. In fact Example 36 shows that strontium hydroxide is ineffective in the amount used. Examples 37 and 40 show that the corresponding oxides of the present invention are more effective than the hydroxides of the prior art, with barium oxide being too effective at 100° C. (the product was so viscous as to be intractable). Reducing the reaction temperature to 80° C. dramatically reduced the effectiveness of BaO (compare Examples 40 and 41), but Examples 42 and 43 showed that, as with the Si—OH+RO—Si condensation reactions of the previous examples, the reaction could be promoted by the addition of a solvent. Again, this is a surprising result, and was certainly not suggested by the prior art (U.S. Pat. No. 5,109,094), where the reactions were performed under conditions of reduced pressure to remove the water by-product as it was formed. Such conditions suggest a mechanism that is counterintuitive to the method of the present invention, where the reaction is facilitated by the addition of a promoter/co-catalytic solvent.

### EXAMPLE 44

In all previous examples of the Si—OH+RO—Si condensation reaction (Examples 1-34), diphenyl silanediol (DPS) was used as the silanol-containing silicon compound. In this example, hydroxy-terminated PDMS (with an average molecular weight of approximately 1750, as used in Examples 36-43) was used as the silanol-containing silicon compound, and reacted with MPS at 80° C. 15.43 g hydroxy-terminated PDMS and 2.21 g MPS were mixed and heated to 80° C. for 30 min, then 0.029 g barium oxide and 0.022 g water were added and the mixture stirred at 80° C. for 1 hr, after which the water (promoter/co-catalyst and condensation by-product) was removed by distillation under reduced pressure. The resin was then filtered through a 0.2 mm filter to remove the barium oxide, and the viscosity at 20° C. measured to be 320 cP, compared to a starting viscosity (for the PDMS) of 102 cP.

Reactions between a silicon containing compound of type (A) (usually diphenyl silanediol) and one or more silicon containing compounds of type (B) (usually a mixture of one or more trialkoxysilanes) have been exemplified with 1:1 ratios of (A):(B) compounds, but it will be appreciated that any ratio of such compounds may be present in the starting material, provided they do not give rise to other unacceptable properties in the final polymer.

The invention has been described by reference to certain preferred embodiments; however, it should be understood that it may be embodied in other specific forms or variations thereof without departing from its spirit or essential characteristics. The embodiments described above are therefore considered to be illustrative in all respects and not restrictive, the scope of the invention being indicated by the appended claims rather than by the foregoing description.

1. A process for the preparation of an organosilicon condensate that comprises reacting together:
at least one silicon containing compound (A) having at least one silanol group; and
at least one silicon containing compound (B) having at least one silicon bonded —OX group wherein X represents at least one chosen from a group comprising hydrogen, an alkyl group having from 1 to 8 carbon atoms, an alkoxyalkyl group having from 2 to 8 carbon atoms, wherein the reaction is in the presence of a catalyst (C) selected from a group comprising strontium oxide, barium oxide, strontium hydroxide, barium hydroxide and mixtures thereof, and at least one solvent (D) selected to allow the reaction to proceed.

2. A process according to claim 1 wherein the organosilicon condensate is a siloxane or polysiloxane.

3. A process according to claim 1 wherein (A) and (B) are independently monomeric, dimeric, oligomeric or polymeric compounds.

4. A process according to claim 1 wherein (A) is a silanol having between one and three unsubstituted or substituted hydrocarbon groups having from 1 to 18 carbon atoms.

5. A process according to claim 4 wherein the silanol is selected from a group comprising diphenyl silanediol, 4-vinyl-diphenyl silanediol and dipentafluorophenyl silanediol.

6. A process according to claim 1 wherein (A) comprises a crosslinkable group.

7. A process according to claim 6 wherein the crosslinkable group is selected from a group comprising an epoxide group, a double bond of the acrylate type, a double bond of the methacrylate type and a double bond of the styrene type.

8. A process according to claim 1 wherein (B) is a monomeric compound with the general formula
G_{y}Si(OR)_{4-y}
wherein y has a value of 0, 1, 2 or 3,
G represents an unsubstituted or substituted hydrocarbon group having from 1 to 18 carbon atoms; and
R represents an alkyl group having from 1 to 8 carbon atoms or an alkoxyalkyl group having from 2 to 8 carbon atoms.

9. A process according to claim 8 wherein (B) is an alkoxysilane, which has from one to four alkoxy groups inclusive.

10. A process according to claim 8 wherein OR is selected from a group comprising methoxy, ethoxy, n-propoxy, i-propoxy, n-butoxy, i-butoxy, s-butoxy and t-butoxy.

11. A process according to claim 8 wherein R and G independently comprise a crosslinkable group.

12. A process according to claim 11 wherein the crosslinkable group is selected from a group comprising an epoxide group, a double bond of the acrylate type, a double bond of the methacrylate type and a double bond of the styrene type.

13. A process according to claim 8 wherein (B) is selected from a group comprising an propyltrimethoxysilane, hexyltrimethoxysilane, octyltrimethoxysilane, decyltrimethoxysilane, dodecyltrimethoxysilane, hexadecyltrimethoxysilane, vinyltrimethoxysilane, phenyltrimethoxysilane, phenylethyltrimethoxysilane, phenylpropyltrimethoxysilane, 3,3,3-trifluoro-propyltrimethoxysilane, nonafluoro-1,1,2,2-tetrahydrohexyl-trimethoxysilane, tridecafluoro-1,1,2,2-tetrahydrooctyl-trimethoxysilane, 3-methacryloxypropyltrimethoxysilane, 3-acryloxypropyltrimethoxysilane, 3-styrylpropyltrimethoxysilane and 3-glycidoxypropyltrimethoxysilane.

14. A process according to claim 1 wherein (B) is an oligomeric or polymeric compound of general formula
R¹₃SiO(SiR¹₂O)ₙSiR¹₂OR
wherein R is chosen from a group comprising an alkyl group having from 1 to 8 carbon atoms and an alkoxyalkyl group having from 2 to 8 carbon atoms, n is an integer ≧0, and each R¹ is chosen from a group comprising an unsubstituted or substituted hydrocarbon group having from 1 to 18 carbon atoms, an alkoxy group having from 1 to 8 carbon atoms, and an alkoxyalkyl group having from 2 to 8 carbon atoms.

15. A process according to claim 1 wherein (A) and (B) are each hydroxy-terminated siloxanes of general formula HO—(SiR¹R²O)ₙ—H
wherein R¹ and R² are chosen from a group comprising unsubstituted or substituted hydrocarbon groups having from 1 to 18 carbon atoms and n is an integer >0.

16. A process according to claim 1 wherein the at least one solvent is present in an amount of from 0.02% to 200% by mole ratio based on the total silicon containing compounds.

17. A process according to claim 1 wherein the at least one solvent comprises a protic solvent.

18. A process according to claim 17 wherein the protic solvent is selected from a group comprising water, methanol, ethanol, 1-propanol, 2-propanol, 1-butanol and 2-butanol.

19. A process according to claim 18 wherein the protic solvent is water, employed in an amount less than 8% by mole ratio based on the total silicon containing compounds.

20. A process according to claim 1 wherein the at least one solvent comprises a non-protic solvent.

21. A process according to claim 1 wherein the catalyst is employed in an amount of from 0.0005 to 5% by mole ratio based on the total silicon containing compounds.

22. A process according to claim 1 further comprising separation of the catalyst from the organosilicon condensate.

23. A process according to claim 1 wherein the organosilicon condensate has a viscosity in the range from 1,000 to 4,000 cP.

24. A process for the preparation of an organosilicon condensate comprising condensing at least one silicon containing compound having:
at least one silanol group (a);
and
at least one —OX group (b),
wherein X is chosen from a group comprising hydrogen, an alkyl group having from 1 to 8 carbon atoms, and an alkoxyalkyl group having from 2 to 8 carbon atoms in the presence of a catalyst (c) selected from a group comprising strontium oxide, barium oxide, strontium hydroxide, barium hydroxide and mixtures thereof, and
at least one solvent (d) selected to allow the reaction to proceed.

25. A process according to claim 24 wherein the at least one solvent is present in an amount of from 0.02% to 200% by mole ratio based on the total silicon containing compounds.

26. A process according to claim 24 wherein the at least one solvent comprises a protic solvent.

27. A process according to claim 26 wherein the protic solvent is selected from a group comprising water, methanol, ethanol, 1-propanol, 2-propanol, 1-butanol and 2-butanol.

28. A process according to claim 27 wherein the protic solvent is water, employed in an amount less than 8% by mole ratio based on the total silicon containing compounds.

29. A process according to claim 24 wherein the at least one solvent comprises a non-protic solvent.

30. A process according to claim 24 wherein the catalyst is employed in an amount of from 0.0005 to 5% by mole ratio based on the total silicon containing compounds.

31. A process according to claim 24 further comprising separation of the catalyst from the organosilicon condensate.

32. A process according to claim 24 wherein the organosilicon condensate has a viscosity in the range from 1,000 to 4,000 cP.

33. A process for the preparation of an organosilicon condensate comprising reacting together:
at least one silicon containing compound (A) having at least one silanol group;
and
at least one silicon containing compound (B) having at least one silicon bonded —OX group wherein X is chosen from a group comprising hydrogen, an alkyl group having from 1 to 8 carbon atoms, or an alkoxyalkyl group having from 2 to 8 carbon atoms in the presence of a catalyst (C) selected from a group comprising strontium oxide, barium oxide, strontium hydroxide, barium hydroxide and mixtures thereof.

34. A process according to claim 33 wherein the catalyst is selected from a group comprising strontium oxide and barium oxide.

35. A process according to claim 33 wherein the organosilicon condensate is chosen from a group comprising siloxane and polysiloxane.

36. A process according to claim 33 wherein (A) and (B) are chosen from a group comprising monomeric, dimeric, oligomeric and polymeric compounds.

37. A process according to claim 33 wherein (A) is a silanol is chosen from a group comprising compounds with from one to three unsubstituted or substituted hydrocarbon groups having from 1 to 18 carbon atoms.

38. A process according to claim 37 wherein the silanol is selected from is chosen from a group comprising diphenyl silanediol, vinyl-diphenyl silanediol and dipentafluorophenyl silanediol.

39. A process according to claim 33 wherein (A) comprises a crosslinkable group.

40. A process according to claim 39 wherein the crosslinkable group is chosen from a group comprising an epoxide group, a double bond of the acrylate type, a double bond of the methacrylate type and a double bond of the styrene type.

41. A process according to claim 33 wherein (B) is a monomeric compound with the general formula
G_{y}Si(OR)_{4-y}
wherein y has a value of 0, 1, 2 or 3,
G is chosen from a group comprising a unsubstituted and a substituted hydrocarbon group having from 1 to 18 carbon atoms; and
R is chosen from a group comprising alkyl groups having from 1 to 8 carbon atoms and alkoxyalkyl groups having from 2 to 8 carbon atoms.

42. A process according to claim 41 wherein (B) is an alkoxysilane, which has from one to four alkoxy groups inclusive.

43. A process according to claim 41 wherein OR is chosen from a group comprising methoxy, ethoxy, n-propoxy, i-propoxy, n-butoxy, i-butoxy, s-butoxy and t-butoxy.

44. A process according to claim 41 wherein R or G are chosen from a group comprising crosslinkable groups.

45. A process according to claim 44 wherein the crosslinkable group is chosen from a group comprising an epoxide group, a double bond of the acrylate type, a double bond of the methacrylate type and a double bond of the styrene type.

46. A process according to claim 41 wherein (B) is chosen from a group comprising propyltrimethoxysilane, hexyltrimethoxysilane, octyltrimethoxysilane, decyltrimethoxysilane, dodecyltrimethoxysilane, hexadecyltrimethoxysilane, vinyltrimethoxysilane, phenyltrimethoxysilane, phenylethyltrimethoxysilane, phenylpropyltrimethoxysilane, 3,3,3-trifluoro-propyltrimethoxysilane, nonafluoro-1,1,2,2-tetrahydrohexyl-trimethoxysilane, tridecafluoro-1,1,2,2-tetrahydrooctyl-trimethoxysilane, 3-methacryloxypropyltrimethoxysilane, 3-acryloxypropyltrimethoxysilane, 3-styrylpropyltrimethoxysilane and 3-glycidoxypropyltrimethoxysilane.

47. A process according to claim 33 wherein (B) is an oligomeric or polymeric compound of general formula
R¹₃SiO(SiR¹₂O)ₙSiR¹₂OR
wherein R is chosen from a group comprising an alkyl group having from 1 to 8 carbon atoms and an alkoxyalkyl group having from 2 to 8 carbon atoms, n is an integer ≧0, and each R¹ is chosen optionally from a group comprising an unsubstituted or substituted hydrocarbon group having from 1 to 18 carbon atoms, an alkoxy group having from 1 to 8 carbon atoms, and an alkoxyalkyl group having from 2 to 8 carbon atoms.

48. A process according to claim 33 wherein (A) and (B) are each hydroxy-terminated siloxanes of general formula HO—(SiR¹R²O)ₙ—H
wherein R¹ and R² represent unsubstituted or substituted hydrocarbon groups having from 1 to 18 carbon atoms and may be the same or different and n is an integer >0.

49. A process according to claim 33 wherein the catalyst is employed in an amount of from 0.0005 to 5% by mole ratio based on the total silicon containing compounds.

50. A process according to claim 33 further comprising separation of the catalyst from the organosilicon condensate.

51. A process according to claim 33 wherein the organosilicon condensate has a viscosity in the range from 1,000 to 4,000 cP.

52. A process for the preparation of an organosilicon condensate comprising condensing at least one silicon containing compound having:
at least one silanol group (a);
and
at least one —OX group (b),
wherein X is chosen from a group comprising hydrogen, an alkyl group having from 1 to 8 carbon atoms, and an alkoxyalkyl group having from 2 to 8 carbon atoms in the presence of catalyst (c) chosen from a group comprising strontium oxide, barium oxide, strontium hydroxide, barium hydroxide and mixtures thereof.

53. A process according to claim 52 wherein the catalyst is chosen from a group comprising strontium oxide and barium oxide.

54. A process according to claim 52 wherein the catalyst is employed in an amount from 0.0005 to 5% by mole ratio based on the total silicon containing compounds.

55. A process according to claim 52 further comprising separation of the catalyst from the organosilicon condensate.

56. A process according to claim 52 wherein the organosilicon condensate has a viscosity in the range from 1,000 to 4,000 cP.
